(19) United States
(12) Patent Application Publication
(10) Pub. No.: US 2019/0073646 A1
(43) Pub. Date: Mar. 7, 2019

(54) CONSOLIDATED BLOCKCHAIN-BASED DATA TRANSFER CONTROL METHOD AND SYSTEM

(71) Applicant: nChain Holdings Limited, St. John's (AG)

(72) Inventors: Craig Steven Wright, London (GB); Stephane Savanah, London (GB)

(21) Appl. No.: 16/079,523

(22) PCT Filed: Feb. 21, 2017
(86) PCT No.: PCT/IB2017/050980

§ 371 Date: Aug. 23, 2018

(30) Foreign Application Priority Data
Feb. 23, 2016 (GB) 1603117.1
Mar. 16, 2016 (GB) 1604498.4
Nov. 15, 2016 (GB) 1619301.3

(51) Int. Cl. G06Q 20/06; G06Q 20/38; G06Q 20/22; G06F 17/30; H04L 9/06

(52) U.S. Cl. CPC G06Q 20/065; G06Q 20/3829; G06Q 20/223; G06Q 20/3827; H04L 2209/38; G06F 17/30283; G06F 17/30206; H04L 9/0643; H04L 2209/56; G06Q 20/389

(57) ABSTRACT

The invention relates to blockchain technologies such as, for example, the Bitcoin blockchain. It provides a method (and corresponding system) of generating public keys for a linked structure of entities, wherein a function is applied to a deterministic key to generate the public key, the deterministic key being generated by applying a hash function to either a parent entity identifier to generate a parent deterministic key, or to a sum of the parent deterministic key and a child entity identifier to generate a child deterministic key. There is also provided a computer-implemented method for accounting on transactions with entities, the transaction being recorded in a peer-to-peer distributed ledger (blockchain), the method comprising: associating public addresses of the entities with one or more identifiers of a first classification type to classify the public addresses based on the first classification type; receiving, from a communication network, a first identifier of the one or more identifiers of the first classification type; determining a first set of public addresses associated with the first identifier, wherein the first set of public address is a subset of the public addresses; and determining a first set of transactions in the peer-to-peer distributed ledger based on the first set of public addresses associated with the first identifier, wherein the first set of transactions is a subset of the transactions.

### TECHNICAL FIELD

The present disclosure relates generally to peer-to-peer distributed technology such as the Bitcoin blockchain. It also relates to the use of cryptographic techniques for the secure and efficient determination and/or identification of transactions on a blockchain, resulting in a technical solution which is highly versatile and can be used to control processes operating in relation to, and interacting with, a blockchain platform. The invention can be used to determine which blockchain transactions (or data therefrom) are to be selected for copying and/or transmission to another computer-based destination.

### BACKGROUND

A blockchain is a peer-to-peer, electronic ledger which is implemented as a computer-based decentralised, distributed system made up of blocks which in turn are made up of transactions. Each transaction is a data structure that encodes the transfer of control of a digital asset between participants in the blockchain system, and includes at least one input and at least one output. Each block contains a hash of the previous block to that blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. Software clients installed on the nodes perform this validation work on an unspent transaction (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be i) validated by the first node that receives the transaction—if the transaction is validated, the node relays it to the other nodes in the network; and ii) added to a new block built by a miner; and iii) mined, i.e. added to the public ledger of past transactions.

As the blockchain offers various advantages, many organisations (entities) have begun to investigate ways in which this technology can be incorporated into their computing infrastructure. Entities may implement complex internal computing systems for the storage and/or processing of their data. For example, these systems may be based on large database structures which are required for handling the volumes of data that is generated and/or captured by the organisation's activities. For example, a financial system may require the management and synchronisation of various databases so that the generated and captured data can be accurately processed or communicated. However, while it is desirable to use blockchain technologies for recording data and events, as the blockchain provides advantages such as a tamper-proof and permanent record, a technical difficulty arises when disparate computing architectures and platforms need to be used in conjunction with one another. The blockchain platform may not interface with the entity's internal systems. Therefore, there is an integration and communication problem arising from the different hardware and software systems being used. The difficulty of identifying and then extracting data from one system (eg blockchain) so that it can be transmitted to a different system (e.g. DBMS) is not a trivial consideration. Furthermore, it is desirable to achieve this cross-platform integration in a way which does not require changes to either underlying platform. Further still, the blockchain stores the data in transactions (Txs) which are built up into blocks. Identifying and the accessing the relevant data from the blockchain is a difficult task, and needs to be performed in a manner which is secure and also efficient, both in terms of time and computational effort. The invention addresses at least these technical concerns.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this document we use the term ‘blockchain’ to include all forms of electronic, computer-based, distributed ledgers. These include consensus-based blockchain and transaction-chain technologies, permissioned and un-permissioned ledgers, shared ledgers and variations thereof. The most widely known application of blockchain technology is the Bitcoin ledger, although other blockchain implementations have been proposed and developed. While Bitcoin may be referred to herein for the purpose of convenience and illustration, it should be noted that the invention is not limited to use with the Bitcoin blockchain and alternative blockchain implementations and protocols fall within the scope of the present invention.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

Method and systems in accordance with the present invention are defined in the appended claims. The invention may provide a cryptographic method and corresponding system. It may provide a blockchain-implemented method/system. It may provide a control system for the secure identification, extraction, transmission, processing and/or update of data. This data may be derived, access or copied from a blockchain. It may provide a method/system of using cryptographic keys to integrate a blockchain with a non-blockchain implemented computing resource such as a data storage/processing resource. It may provide a method/system of using cryptographic keys to identify and/or extract data from a blockchain. It may provide a method/system for integrating that blockchain-sourced data into a non-blockchain implemented storage resource. The entity may be referred to as an organisation, system or network. It may be a logical entity, a virtual, computer-based or a physical entity. It may comprise natural person(s).

There may be provided a computer-implemented method for efficient identification, association or determination of blockchain transactions (Txs) with one or more entities. The blockchain transactions may be recorded in a peer-to-peer distributed ledger (blockchain).

The method may comprise the steps:

associating public addresses of the entities with one or more identifiers of a first classification type to classify the public addresses based on the first classification type; this may involve logically linking or associating the public addresses with at least one identifier, the identifier belonging to a classification type;

receiving, from a communication network, a first identifier of the one or more identifiers of the first classification type;

determining a first set of public addresses associated with the first identifier, wherein the first set of public address is a subset of the public addresses; and

identifying a first set of transactions in the blockchain based on the first set of public addresses associated with the first identifier. The first set of transactions may be a subset of the transactions on the blockchain.

The method may further comprise the steps of extracting or copying at least a portion of data from the first set of blockchain transactions (which may be called “transaction data”) and/or transmitting the extracted transaction data to a computing resource which is not part of the blockchain platform or network.

A public address may be derived from, or based on, a cryptographic key. This may be a deterministic key.

Additionally or alternatively, the invention may provide a method of generating public keys for a linked or associated structure of entities, wherein a function is applied to a deterministic key to generate the public key, the deterministic key being generated by applying a hash function to either a parent entity identifier to generate a parent deterministic key, or to a sum of the parent deterministic key and a child entity identifier to generate a child deterministic key.

The key may form part of a public/private key pair. There may be one key or key pair which is designated as the “master” or “root” key/pair. Sub-entities, units or elements within an entity may be associated with sub-keys or pairs which are derived from the root. The sub-keys may be generated in a deterministic manner. The sub-key may be generated or determined substantially as described in the example provided below. A sub-key may be generated, derived or determined based on another (preceding) key. Generation of the sub-key may comprise the use of ECC techniques. A sub-key may be generated, derived or determined using a deterministic key (DK) that is based on a cryptographic hash of a message (M) or identifier. The message or identifier may be random, pseudo-random, pre-defined or selected. In a preferred embodiment, the message/identifier is selected, arranged or created to correspond to a meaningful value such as, for example, an account number, patient ID, network node identifier, company identifier etc. The message or identifier may have some meaning in relation to the entity or a sub-entity/element. The message may provide a link, association or reference to the entity or element. A sub-key may be determined based on a scalar addition of the associated public parent key and the scalar multiplication of the deterministic key and a generator (G). The message/identifier may be stored within or as metadata in a blockchain transaction (Tx). The message/identifier may be rehashed in order to provide a further sub-key.

In some embodiments of the invention, the method may include steps to associate the public addresses of the entities with the one or more identifiers of the first classification type to classify the public addresses based on the first classification type. This way, the method is able to efficiently determine transactions (Txs) that are recorded in the peer-to-peer distributed ledger (blockchain) based on the classified public addresses. As a result, the method disclosed in the present disclosure is particularly useful for any type of system in which data needs to be identified and/or extracted from transactions that have been posted to a blockchain. Examples of useful applications may include accounting and reporting on the transactions recorded in the blockchain, but it is important to note that the invention is not limited with regard to this use, application or context.

The method may further comprise:

receiving, from the communication network, a first data item associated with the first identifier;

generating a first data output based on the first account item and the first set of transactions.

For the sake of convenience and simplicity, and in a non-limiting manner, the data item may be referred to as an “accounting item” and the data output may be referred to as an “accounting report”.

The method may further comprise:

receiving, from a communication network, a second accounting item associated with a second identifier of the one or more identifiers of the first classification type;

determining a second set of public addresses associated with the second identifier, wherein the second set of public addresses is a subset of the public addresses;

determining a second set of transactions in the peer-to-peer distributed ledger based on the second set of public addresses associated with the second identifier, wherein the second set of transactions is a subset of the transactions;

generating a second accounting report based on the second accounting item and the second set of transactions;

performing a first hash operation on the first accounting report to generate a first report hash representation for the first accounting report;

performing a second hash operation on the second accounting report to generate a second report hash representation for the second accounting report; and

combining the first report hash representation and the second report hash representation;

perform a third hash operation on the combined first report hash representation and second report hash representation to generate a third hash representation for the combined first report hash representation and second report hash representation.

The method may further comprise storing the third report hash representation in a storage device.

The method may further comprise:

combining the first accounting report and the second accounting report;

performing a hash operation on the combined first accounting report and second accounting report to generate a hash representation for the combined first accounting report and second accounting report.

The method may further comprise:

associating the public addresses of the entities with one or more identifiers of a second classification type to classify the public addresses based on the second classification type;

receiving, from the communication network, a third identifier of the one or more classification identifiers of the second classification type;

determining a third set of public addresses associated with the third identifier and the first identifier, wherein the third set of public addresses is a subset of the public addresses; and

determining a third set of transactions in the peer-to-peer distributed ledger based on the third set of public addresses associated with the third identifier and the first identifier, wherein the third set of transactions is a subset of the transactions.

The first classification type may represent a classification of the public addresses by identity of the entities.

The one or more identifiers of the first classification type may include one or more of the following:

names of the entities;

hexadecimal codes of the names;

network node identifier;

Australian Business Numbers of the entities; and/or

Australian Company Numbers of the entities.

The second classification type may represent a classification of the public addresses by account type of the entities.

The one or more identifiers of the second classification type may comprise any one or more of the following accounts:

credit account;

debit account;

accounts receivable;

accounts receivable;

salary account; and

interest account.

Associating the public addresses of the entities with the one or more identifiers of the first classification type may comprise:

storing, in entries of a look-up table, the one or more identifiers of the first classification type in association with the public addresses of the entities, each entry of the look-up table including one of the one or more identifiers of the first classification type and one of the public addresses.

Associating the public addresses of the entities with the one or more identifiers of the first classification type may comprise:

using a script to associate the one or more identifiers of the first classification type with the public addresses in the peer-to-peer distributed ledger.

The first classification type may represent a classification of the public addresses by a tree structure that links the entities.

The one or more identifiers of the first classification type may comprise deterministic keys associated the entities, wherein the deterministic keys are generated based on the tree structure.

The entities may include a parent entity and a child entity associated with the parent entity in the tree structure, wherein

the parent entity is associated with a first deterministic key of the deterministic keys, and the child entity is associated with a second deterministic key of the deterministic keys, and

the first deterministic key is determined based on a parent indication associated with the parent entity, and the second deterministic key is determined based on the first deterministic key and a child indication associated with the child entity.

The method may further comprise:

receiving the parent indication from the communication network;

determining the first deterministic key based on the parent indication;

determining the second deterministic key based on the first deterministic key and the child indication;

determining a fourth set of public addresses associated with the second deterministic key, wherein the fourth set of public addresses is a subset of the public addresses;

determining a fourth set of transactions in the peer-to-peer distributed ledger based on the fourth set of public addresses associated with the second deterministic key, wherein the fourth set of transactions is a subset of the transactions; and

generating a third accounting report based on the fourth set of transactions.

Determining the fourth set of public addresses may further comprise determining the fourth set of public addresses based on the second deterministic key.

The public addresses may comprise public keys of asymmetric cryptography pairs, each of the asymmetric cryptography pairs including one of the public keys and a private key corresponding to the one of the public keys.

The peer-to-peer distributed ledger may be a blockchain generated in accordance with a Bitcoin protocol.

The public addresses may comprise Bitcoin addresses of the entities used in the Bitcoin protocol.

There is provided a computer software program, including machine-readable instructions, when executed by a processor, causes the processor to perform any one of the methods as described above.

There is provided a computer system for efficient determination of transactions with entities, the transactions being recorded in a peer-to-peer distributed ledger, the computer system comprising:

a processor configured to
associate public addresses of the entities with one or more identifiers of a first classification type to classify the public addresses based on the first classification type;
receive, from a communication network, a first identifier of the one or more identifiers of the first classification type;
determine a first set of public addresses associated with the first identifier, wherein the first set of public addresses is a subset of the public addresses; and
determine a first set of transactions in the peer-to-peer distributed ledger based on the first set of public addresses associated with the first identifier, wherein the first set of transaction is a subset of the transactions.

The invention may provide a method of generating public keys for a linked or associated structure of entities. It may comprise the step of:

applying a function to a deterministic key to generate a public key, the deterministic key being generated by applying a hash function to either a parent entity identifier to generate a parent deterministic key, or to a sum of the parent deterministic key and a child entity identifier to generate a child deterministic key. This method may further comprise any feature(s) described above.

Any feature mentioned above in respect of a method of the invention may be applicable to a corresponding system, and vice versa.

### BRIEF DESCRIPTION OF DRAWINGS

Features of the present disclosure are illustrated by way of non-limiting examples, and like numerals indicate like elements, in which:

FIG. 1 illustrates a cryptocurrency system including an accounting server in accordance with the present disclosure;

FIG. 2 illustrates a computer-implemented method for efficient determination of transactions on a peer-to-peer distributed ledger in accordance with the present disclosure;

FIG. 3(a) illustrates an example of associating public addresses of entities with identifiers of a classification type in accordance with the present disclosure;

FIG. 3(b) illustrates an example of associating public addresses of the entities with identifiers of more than one classification type in accordance with the present disclosure;

FIGS. 4(a) and 4(b) illustrate an example application of the present disclosure to an entity network configured in a tree structure; and

FIG. 5 illustrates an example schematic diagram of a computer system used to implement methods described in the present disclosure.

### DESCRIPTION OF EMBODIMENTS

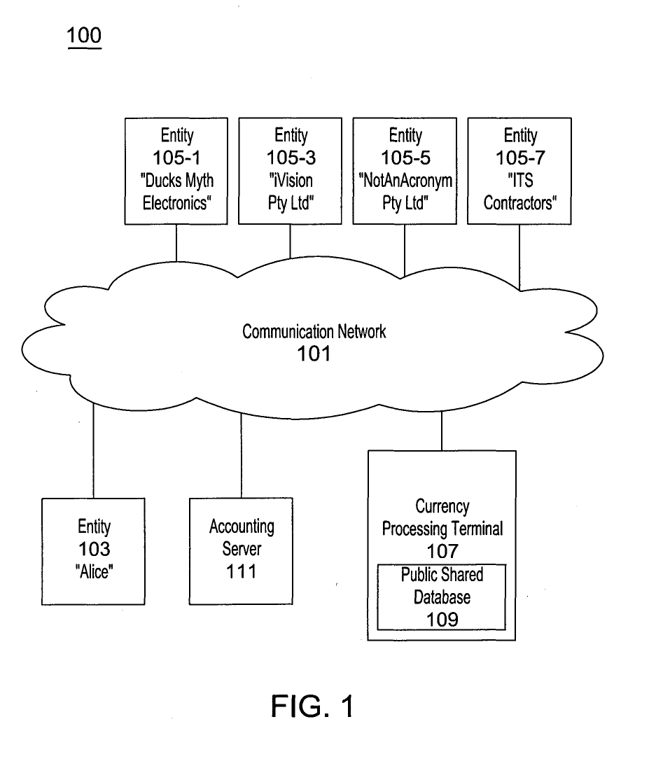

FIG. 1 illustrates a cryptocurrency system 100 including a server 111 in accordance with the present disclosure. In this example, the server is an accounting server but in other embodiments the server could be arranged for other types of purpose or functionality.

The cryptocurrency system 100 provides a platform for entities 103, 105-1 to 105-7 to send and receive cryptocurrency. Entities 103, 105-1 to 105-7 are connected to each other by a communication network 101. The cryptocurrency system 100 in the present disclosure uses a peer-to-peer distributed ledger (i.e. blockchain) 109 to record transactions (Txs) conducted over the cryptocurrency system 100. A copy of the (i.e. blockchain) 109 is stored on a currency processing terminal 107. Although there is only one currency processing terminal 107 shown in FIG. 1, there may be more than one currency processing terminals 107 in the cryptocurrency system 100 without departing from the scope of the present disclosure.

The cryptocurrency system 100 in the present disclosure is described as a Bitcoin system 100 using a blockchain for description purposes. In another example, the cryptocurrency system 100 can be other cryptocurrency platforms, for example, Ethereum. Further, although the cryptocurrency system 100 and methods in the present disclosure are described in the context of accounting and reporting on the transactions recorded in the (i.e. blockchain) 109, the cryptocurrency system 100 and these methods can be used in different ways. The invention is not limited to use for accounting purposes.

In the Bitcoin system 100, one or more transactions (Txs) may be conducted between entity 103 and entities 105-1 to 105-7. For example, a certain number of bitcoins (BTC) are transferred from entity 103 to entity 105-1. Transactions are defined and processed according to Bitcoin protocols. An example Bitcoin transaction (Tx) is shown in Table 1 below.

TABLE 1
Example Bitcoin transaction

{

“hash”:“f4184fc596403b9d638783cf57adfe4c75c605f6356fbc91338530e9

831e9e16”,

“ver”:1,
“vin_sz”:1,
“vout_sz”:2,
“lock_time”:0,
“size”:275,
“in”:[

{

“prev_out”:{

“hash”:“0437cd7f8525ceed2324359c2d0ba26006d92d856a9c20fa0241

106ee5a597c9”,

“n”:0

},
“scriptSig”:“304402204e45e16932b8af514961a1d3a1a25fdf3f4f7732e9

d624c6c61548ab5fb8cd410220181522ec8eca07de4860a4acdd12909d831cc
56cbbac4622082221a8768d1d0901”

}

],
“out”:[

{

“value”:“10.00000000”,
“scriptPubKey”:“04ae1a62fe09c5f51b13905f07f06b99a2f7159b2225f3

74cd378d71302fa28414e7aab37397f554a7df5f142c21c1b7303b8a0626f1b
aded5c72a704f7e6cd84c OP_CHECKSIG”

},
{

“value”:“40.00000000”,
“scriptPubKey”:“0411db93e1dcdb8a016b49840f8c53bc1eb68a382e97b

1482ecad7b148a6909a5cb2e0eaddfb84ccf9744464f82e160bfa9b8b64f9d4c
03f999b8643f656b412a3 OP_CHECKSIG”

}

]

}

The above transaction in Table 1 is a data structure which is arranged in accordance with the blockchain protocol, and includes a plurality of fields and scripts. These fields and scripts contain information and commands used by the currency processing terminal 107 to implement a Bitcoin transaction (Tx). It should be noted that transactions may have different fields and scripts for different purposes.

A transaction (Tx) typically contains a brief description of the transaction, including, for example, a hash value of the transaction, a version number of the Bitcoin protocol, the number of inputs, the number of outputs, the size of the transaction, etc.

The “Input” field (“In”) contains a reference to a previous transaction (“prev_out”) from which the bitcoins are received. And the “Output” field (“Out”) contains the number of the bitcoins (“value”) to be sent to a public address or a Bitcoin address used by an entity, and the public address or a Bitcoin address (contained in “scriptPubKey”) that the bitcoins are sent to. In the example shown in Table 1, bitcoins received from a previous transaction “0437cd7f8525ceed2324359c2d0ba26006d92d856a9c20fa0241106ee5a597c9” are sent to two public addresses.

The above transaction is transferred to the currency processing terminal 107, which may also be referred to as a “miner” in Bitcoin protocols. The currency processing terminal 107 groups a certain number (i.e, a block) of transactions that happened in the past, and verifies these transactions using a proof of work mechanism.

Once the block is verified, the verified block is combined with other blocks that have been verified previously. These blocks constitute the peer-to-peer distributed ledger 109, referred to as a “blockchain” in Bitcoin or Ethereum protocols. A copy of the blockchain 109 is stored on the currency processing terminal 107, and can be accessed by the public. Transactions that are recorded in the blockchain of a Bitcoin system may be found at, for example, https://blockchain.info.

As known in relation to the Bitcoin protocol, an address is a hashed version of a cryptographic public key. The public key forms part of a public/private key pair and so every address is inked to a private key that is owned by or associate with an entity (human, logical, virtual or computer based entity).

It should be noted that in the cryptocurrency system 100 operating according to Bitcoin protocols in which a blockchain is used, entities 105-1 to 105-7 receiving bitcoins may have multiple public or Bitcoin addresses to receive bitcoins from entity 103. On the other hand, entity 103 may have multiple public or Bitcoin addresses to receive bitcoins from entities 105-1 to 105-7. Therefore, it is difficult to identify the transactions associated with a certain classification. For example, it is difficult to identify the transactions associated with a particular entity by accessing the blockchain. Further, it is also difficult to identify transactions associated with a particular account type (e.g., debit account, credit account, etc.). This results in difficulties in using data stored on a blockchain for off-block purposes. For example, if an organisation wishes to utilise a blockchain platform for currency transfer purposes in order to harness the advantages provided by blockchain-implemented technologies, they may need to import the relevant data from the blockchain into an internal system such as a database on a server for further storage and/or processing. This data extraction process becomes a difficult technical task because of the problems in identifying the relevant blockchain transactions (Tx) as explained above. For example, it becomes difficult to use the data for, say, accounting, communicating, processing or reporting on transactions which have been recorded in the blockchain 109.

In this example, for the sake of simplicity, we will discuss the use of an embodiment of the invention for accounting reports. An accounting report is used in the present disclosure to report on the transactions that have been recorded in the blockchain. The accounting report includes one or more accounting items. An account item can take different forms. Essentially, an account item represents a question to be answered. For example, an accounting item may represent a question of “how many transactions have been conducted with entity 105-1?”. The answer to this question is a value representing the number of transactions with entity 105-1.

Accounting items to be included in an accounting report may be presented on a user interface for a user associated with an entity to select. For example, the accounting items are presented on a computer screen of a computer that the user is using. The user selects one or more of the accounting items to be included in the accounting report using an input device (e.g., a keyboard, a pointing device, or a touch screen) associated with the computer. Once the accounting items are selected by the user, these accounting items are sent to the accounting server 111 over a communication network 101. Subsequently, a method as described below is performed on the accounting server 111 to calculate values that correspond to the selected one or more of the accounting items.

The accounting server 111 further generates the accounting report by incorporating the selected one or more of the accounting items and the corresponding values into an electronic file. Particularly, the accounting report can be an electronic spreadsheet including the selected one or more of the accounting items and the corresponding values. The accounting reporting generated may be stored in a storage device or sent to the computer the user is using or another computer that user designated beforehand.

Example accounting items that may be selected by an user associated with entity 103 are shown in Table 2. These accounting items include accounting items 1 to 5 in relation to entity 105-1 (“Ducks Myth Electronics”) that entity 103 conducts transactions with.

TABLE 2
Example Accounting Items

1. The number of transactions with entity 105-1
2. The number of payments received from entity 105-1
3. Total payment received from entity 105-1
4. The number of payments made to entity 105-1
5. Total payment made to entity 105-1

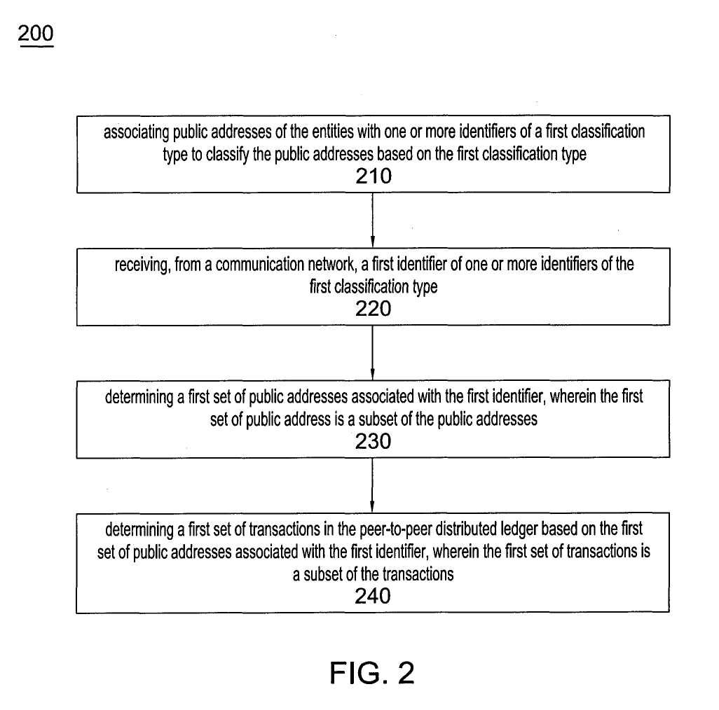

FIG. 2 illustrates a computer-implemented method 200 for efficient determination of transactions with entities in accordance with the present disclosure. The transactions are conducted via the cryptocurrency system 100 and recorded in the blockchain 109.

In this example, method 200 is implemented on the accounting server 111 to account on the transactions associated with entity 103.

Specifically, method 200 associates 210 public addresses of the entities 105-1 to 105-7 with one or more identifiers of a first classification type to classify the public addresses based on the first classification type.

The first classification type represents a classification of the public addresses in a certain way. The first classification type in this example represents a classification of the public addresses by identity of the entities 103, 105-1 to 105-7. Accordingly, the one or more identifiers of the first classification type indicate specific identities of the entities 103, 105-1 to 105-7. The identify of an entity in the presented disclosure may be represented by a name of the entity, or a hexadecimal code of the name that is converted from the name of the entity. As shown in FIG. 1, for example, the name of entity 103 is “Alice”, and the name of entity 105-1 is “Ducks Myth Electronics”. In other examples, identity of an entity can also be represented by an Australian Business Number (ABN), an Australian Company Number (ACN), or an internal alphanumeric client identifier such as “ABC14114800389”.

In other examples, the public addresses may be classified in different ways. For example, the public addresses can be classified by account type of the entities. Accordingly, the one or more identifiers of the first classification type indicate specific account types associated with the public addresses, including any one or more of the following accounts: credit account, debit account, accounts receivable, accounts payable, salary account, and interest account. The identifiers may indicate other types of accounts without departing from the scope of the present disclosure.

As an example, entity 103 conducts a transaction with entity 105-1 and the name of entity 105-1 is “Ducks Myth Electronics”. Method 200 associates the name of entity 105-1 with this transaction.

Once the association is established, method 200 uses the association to account on the transactions. For example, a user associated with entity 103, using an input device associated with his or her computer, selects accounting item 1 (e.g., “The number of transactions with entity 105-1”) associated with the first identifier (i.e., “Ducks Myth Electronics”). The selected accounting item 1 is sent to the accounting server 111 over the communication network 101.

At the accounting server 111, method 200 receives 220 from the communication network 101 the first identifier (“Ducks Myth Electronics”). Particularly, method 200 receives, from the communication network 101, accounting item 1 associated with the first identifier (“Ducks Myth Electronics”);

Method 200 further determines 230 a first set of public addresses associated with the first identifier (“Ducks Myth Electronics”) from the association established in step 210, wherein the first set of public address is a subset of the public addresses. Specifically, method 200 searches the association by the first identifier (“Ducks Myth Electronics”) to determine the first set of public addresses associated with the first identifier (“Ducks Myth Electronics”). As a result, the first set of public addresses that are used by “Ducks Myth Electronics” is determined.

Method 200 further determines 240 a first set of transactions in the peer-to-peer distributed ledger 109 (particularly, the blockchain 109 in this example) based on the first set of public addresses associated with the first identifier (“Ducks Myth Electronics”), wherein the first set of transactions is a subset of the transactions recorded in the blockchain 109. For example, method 200 downloads the blockchain 109 from the currency processing terminal 107 and searches the blockchain 109 for transactions having any one of the first set of public addresses used by “Ducks Myth Electronics”. As a result, all the transactions that are conducted with “Ducks Myth Electronics” are determined.

Based on accounting item 1 (“The number of transactions with entity 105-1”) and the first set of transactions determined above, method 200 generates a first accounting report. For example, method 200 determines a corresponding value indicating the number of transactions with entity 105-1 (“Ducks Myth Electronics”) by counting the number of transactions in the first set of transactions. Further, method 200 generates the first accounting report by creating an electronic spreadsheet including accounting item 1 (“The number of transactions with entity 105-1”) and their corresponding value.

The user may select multiple accounting items. In this case, method 200 repeats steps 210 to 240 and, generate an accounting report including these accounting items and corresponding values. An example accounting report is shown in Table 3 below:

TABLE 3
Example Accounting Report

| Accounting Items | Value |
|---|---|
| The number of transactions with “Ducks Myth Electronics” | 2 |
| Total payment made to “Ducks Myth Electronics” | $15,000 |
| The number of transactions with “iVision Pty Ltd” | 1 |
| Total payment made to “iVision Pty Ltd” | $1,000 |

As can be seen from the above, based on different accounting items, method 200 can generate different accounting reports for accounting purposes, including a Balance Sheet, an Income Statement, an Inventory Report, a Shipping and Receiving Report, a Custom Report, a Billing and Paying Report, and even other reports for purposes other than accounting purposes without departing from the scope of the present disclosure. An example Balance Sheet and an example Income Statement are shown in Table 4 and Table 5, respectively.

TABLE 4
Example Balance Sheet

| Assets | Value | Liabilities | Value |
|---|---|---|---|
| Inventory | $50,000 | Accounts Payable | $30,000 |
| Cash | $40,000 | | |
| Total Assets | $90,000 | Total Liabilities | $30,000 |

TABLE 5
Example Income Statement

| Income | Value |
|---|---|
| Gross Sales | $400,000 |
| Discounts | $5,000 |
| Net Revenue | $395,000 |
| Cost of Sales | $200,000 |
| Gross Profit | $195,000 |
| Operating Expense | $60,000 |
| Operating Income | $135,000 |
| Tax Expense | $20,000 |
| Net Profit | $115,000 |

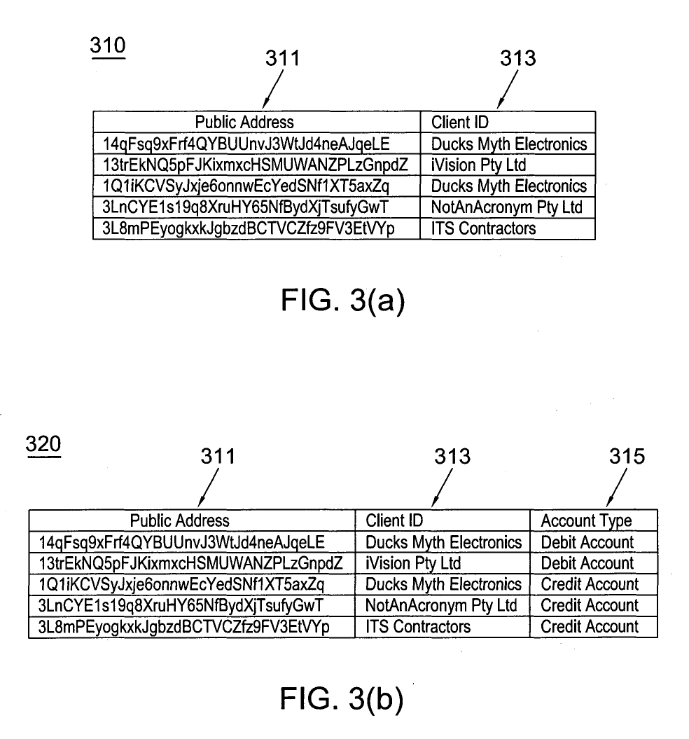

FIG. 3(a) illustrates an example of associating public addresses of the entities with identifiers of a classification type in accordance with the present disclosure.

In the example shown in FIG. 3(a), a look-up table 310 is used to associate public addresses of the entities with identifiers of a classification type. Each entry of the look-up table 310 includes two fields, a “Public Address” field 311 and a “Client ID” field 313. The value of the “Public Address” field 311 of an entry indicates a specific public address used in a transaction, and the value of the “Client ID” field 313 of an entry indicates the specific identity of the entity associated with the public address. It should be noted that, in another example, the “Client ID” field 313 may be replaced with a different classification type, for example, account type, to classify a public address by account type associated with the public address.

A transaction in relation to entity 103 occurs with an entity using a public address that is not stored in the look-up table 310, method 200 adds an entry to the look-up table 310. For example, a payment is made from entity 103 to a public address used by entity 105-1 (“Ducks Myth Electronics”) that is not stored in the look-up table 310, method 200 adds an entry to the look-up table 310 and stores an identifier of entity 105-1 (“Ducks Myth Electronics”) in the entry of the look-up table 310 in association with the public address used by entity 105-1 (“Ducks Myth Electronics”), as shown in the first entry and the third entry of the look-up table 310. As a result, each entry of the look-up table 310 associates one of the identifiers of a certain classification type and one of the public addresses by including them in the entry.

In this case, if an accounting item associated with entity 105-1 (“Ducks Myth Electronics”) is selected by a user, and the accounting item is sent to the accounting server 111 over the communication network 101, method 200 searches the look-up table 310 for entries having “Ducks Myth Electronics” in the “Client ID” field 313 to determine the first set of public addresses used by “Ducks Myth Electronics” (i.e., entity 105-1). In this example, the first set of public addresses determined in this example includes the public addresses contained in the first entry and the third entry of the look-up table 310.

Further, method 200 determines the first set of transactions in the peer-to-peer distributed ledger 109 (particularly, the blockchain 109) based on the first set of public addresses associated with entity 105-1 (“Ducks Myth Electronics”), as described above with reference to step 240. Therefore, the first set of transactions that are conducted with “Ducks Myth Electronics” are determined. Method 200 may further generate the first accounting report based on the first set of transactions, as described above. The first accounting report is sent from the accounting server 111 to the computer that the user is using or a computer that the user designated beforehand, and displayed on the screen of the computer for the user or a third-party to review.

In another example, the user further selects a second accounting item (for example, “the number of transactions with entity 105-3”) associated with a second identifier (“iVision Pty Ltd”, i.e., entity 105-3) of the first classification type. The user sends the second accounting item to the accounting server 111 over the communication network 101.

Method 200 receives, from the communication network 101, the second accounting item associated with the second identifier (“iVision Pty Ltd”) of the first classification type. Method 200 further determines a second set of public addresses associated with the second identifier (“iVision Pty Ltd”), wherein the second set of public addresses is a subset of the public addresses. Particularly, method 200 searches the look-up table 310 for entries having “iVision Pty Ltd” in the “Client ID” field 313 to determine the second set of public addresses used by “iVision Pty Ltd” (i.e., entity 105-3). The second set of public addresses determined in this example includes the public address contained in the second entry of the look-up table 310.

Method 200 then determines a second set of transactions in the blockchain 109 based on the second set of public addresses associated with the second identifier (“iVision Pty Ltd”), wherein the second set of transactions is a subset of the transactions in the blockchain 109.

Method 200 further generates a second accounting report based on the second accounting item and the second set of transactions, as described above.

Method 200 further performs a first hash operation on the first accounting report as generated above to generate a first report hash representation for the first accounting report, and performs a second hash operation on the second accounting report to generate a second report hash representation for the second accounting report. Method 200 combines the first report hash representation and the second report hash representation. Method further performs a third hash operation on the combined first report hash representation and second report hash representation to generate a third hash representation for the combined first report hash representation and second report hash representation. This way, the first report hash representation and second report hash representation are consolidated into a single hash representation.

In another example, method 200 combines the first accounting report and the second accounting report, and performs a hash operation on the combined first accounting report and second accounting report to generate a hash representation for the combined first accounting report and second accounting report.

The look-up table 310 may include an additional field (referred to as a second classification type hereinafter) to classify the public addresses of the entities by two classification types. This way a public address associated with an entity is classified by both the identity of the entity and the account type associated with the public address. Further, a public address may be classified by even more classification types without departing from the scope of the present disclosure.

FIG. 3(b) illustrates an example of associating public addresses of the entities with identifiers of more than one classification types in accordance with the present disclosure.

In the example shown in FIG. 3(b), each entry of the look-up table 320 includes a further “Account Type” field 315 (i.e., the second classification type) in addition to the “Public Address” field 311 and the “Client ID” field 313 (i.e., the first classification type as described above) in order to further classify a public address based on the account type associated with the public address. The identifiers for account type represent specific account types, including one or more of credit account, debit account, accounts receivable, accounts payable, salary account, and interest account. The identifiers may represent other types of accounts without departing from the present disclosure.

In this case, if a payment is made from entity 103 to a public address used by entity 105-1 (“Ducks Myth Electronics”), in addition to storing the identity identifier of entity 105-1 (“Ducks Myth Electronics”) in a new entry of the look-up table 320 in association with the public address used by entity 105-1 (“Ducks Myth Electronics”), as described above with reference to FIG. 3(a), method 200 further associates the public address with a specific account type associated with the public address to classify the public addresses by account type. As shown in the first entry of the look-up table 320, the public address in the first entry is further associated with a “Debit Account”, and the public address in the third entry is further associated with a “Credit Account”.

The user selects a third accounting item (for example, “the number of transactions on credit account with entity 105-1”) associated with the first identifier (“Ducks Myth Electronics”, i.e., entity 105-1) of the first classification type (i.e., identity of the entity) and a third identifier (“Credit Account”) of the second classification type (i.e., account type associated with the public address). The user sends the third accounting item to the accounting server 111 over the communication network 101.

Method 200 receives, from the communication network 101, the third accounting item associated with the first identifier (“Ducks Myth Electronics”) of the first classification type and the third identifier (“Credit Account”) of the second classification type. Method 200 further determines a third set of public addresses associated with the third identifier (“Credit Account”) and the first identifier (“Ducks Myth Electronics”), wherein the third set of public addresses is a subset of the public addresses. In the example shown in FIG. 3(b), method 200 searches the look-up table 320 for entries having both “Ducks Myth Electronics” in the “Client ID” field 313 and “Credit Account” in the “Account Type” field 315 to determine the third set of public addresses used by “Ducks Myth Electronics” (i.e., entity 105-1) on a credit account. As shown in FIG. 3(b), the third set of public addresses determined in this example only includes the public address contained in the third entry of the look-up table 320.

Method 200 further determines a third set of transactions in the peer-to-peer distributed ledger 109 (particularly, the blockchain 109) based on the third set of public addresses, wherein the third set of transactions is a subset of the transactions. Method 200 may further generate a further accounting report based on the third set of transactions and store the further accounting report in a storage device, as described above.

It should be noted that the entries shown in the look-up table 310 or 320 may represent part of the transactions conducted in relation to entity 103, and the look-up table 310 or 320 may include more entries in other examples.

A further example of associating public addresses of the entities with identifiers of a classification type in accordance with the present disclosure is described below.

In this example, if a payment is made from entity 103 to a public address used by entity 105-1 (“Ducks Myth Electronics”), method 200 associates the public address used by entity 105-1 with the identity identifier (“Ducks Myth Electronics”) of entity 105-1 in the transaction itself. For example, method 200 uses a script in the transaction to associate the public address used by entity 105-1 with the identity identifier (“Ducks Myth Electronics”) of entity 105-1 in the blockchain 109.

In this case, if an accounting item associated with entity 105-1 (“Ducks Myth Electronics”) is selected by a user, and the accounting item is sent to the accounting server 111 over the communication network 101. Method 200 searches the blockchain 109 for transactions that match the public address used by “Ducks Myth Electronics” to determine the transactions in the blockchain 109 that are conducted with “Ducks Myth Electronics”. Method 200 may further generate an accounting report based on the transactions determined above. Method 200 may further store the accounting report in a storage device.

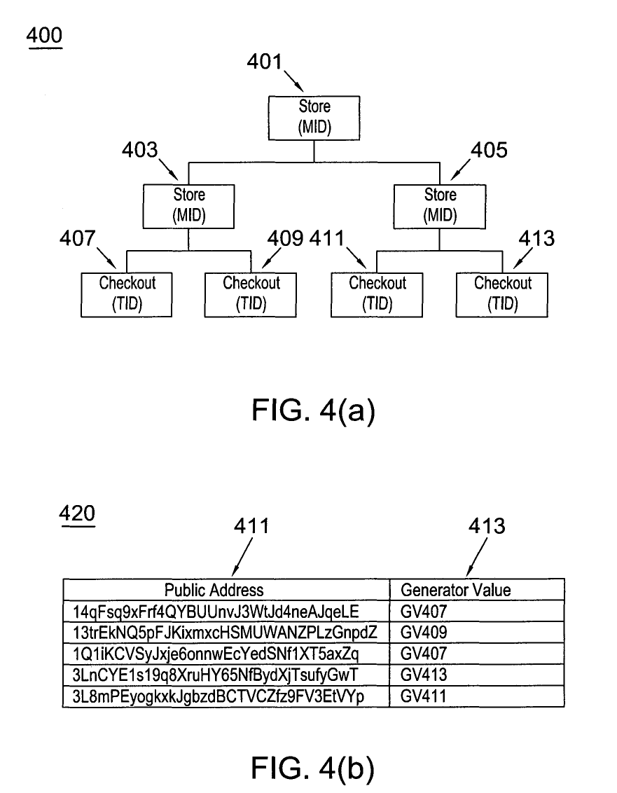

FIGS. 4(a) and 4(b) illustrate an example application of the present disclosure to an entity network configured in a tree structure.

In the example application shown in FIG. 4(a), an entity network 400 includes multiple entities 401 to 413 that are configured in a tree structure. Although the entity network 400 are shown in FIG. 4(a) to represent a retailers network that are traditionally structured in a tree structure, the entity network 400 may represent other entity networks without departing from the scope of the present disclosure.

In order to classify the public addresses associated with checkout terminals 407 to 413 that are configured in the tree structure shown in FIG. 4(a), a classification type called “Deterministic Key” is introduced in this example, shown as the “Deterministic Key” field 413 in the look-up table 420 in FIG. 4(b). Accordingly, identifiers for this classification type represent specific deterministic keys associated with each of entities 401 to 413 that are linked by the tree structure.

As shown in FIG. 4(a), the stores and checkout terminals 401 to 413 in the retailers network 400 are configured in a tree structure. Specifically, entity or store 401 is at the top of the tree and has two child entities or stores 403 and 405. Child entity or store 403 is also a parent entity of child entities 407 and 409, which are checkout terminals installed in store 403 or associated with store 403. Similarly, child entity or store 405 is also a parent entity of child entities 411 and 413, which are checkout terminals installed in store 405 or associated with store 405. Each of stores 401 to 405 has an associated merchant indication (MID) (for example, the name of the store), and each of checkout terminals 407 to 413 has an associated terminal indication (TID) (for example, a manufacturer identification number assigned to the checkout terminal). Transactions are conducted at checkout terminals 407 to 413 using public addresses associated with checkout terminals 407 to 413.

Deterministic keys associated with entities 401 to 413 are determined in a way the deterministic keys are mapped to entities 401 to 413 deterministically. Specifically, the deterministic key associated with root entity or store 401 is based on the MID associated with root entity or store 401. For example, the deterministic key associated with root entity or store 401 can be determined by performing a set of cryptographic functions based on the MID associated with root entity 401. An example of generating the generator value (“GV401”) associated with root entity 401 using a cryptographic hash algorithm SHA-256 based on the MID (“MID401”) associated with root entity 401 is shown below

GV401=SHA-256(MID401) (Equation-1)

For child entities or stores 403 and 405, the deterministic key (for example, “GV403” for store 403 or “GV405” for store 405) associated with each of child entities or stores 403 and 405 is determined based on the deterministic key (i.e., “GV401”) associated with its parent entity 401 (in this case, root entity 401) and its own MID (for example, “MID403” for store 403 or “MID405” for store 405). For example,

GV403=SHA-256(GV401+MID403) (Equation-2)

GV405=SHA-256(GV401+MID405) (Equation-3)

For checkout terminals 407 and 409, the deterministic key (for example, “GV407” for checkout terminal 407, or “GV409” for checkout terminal 409) associated with each of checkout terminals 407 and 409 is determined based on the deterministic key associated (i.e., “GV403”) with its parent entity 403 and its own TID (for example, “TID407” for checkout terminal 407 or “TID409” for checkout terminal 409). Similarly, for checkout terminals 411 and 413, the deterministic key (for example, “GV411” for checkout terminal 411, “GV413” for checkout terminal 413) associated with each of checkout terminals 411 and 413 is determined based on the deterministic key (i.e., “GV405”) associated with its parent entity 405 and its own TID (for example, “TID411” for checkout terminal 411 or “TID413” for checkout terminal 413). For example,

GV407=SHA-256(GV403+TID407) (Equation-4)

GV409=SHA-256(GV403+TID409) (Equation-5)

GV411=SHA-256(GV405+TID411) (Equation-6)

GV413=SHA-256(GV405+TID413) (Equation-7)

Further, these deterministic key are used to derive respective public addresses used by stores 401 to 405 and checkout terminals 407 to 413. For example,

public address=F(deterministic key) (Equation-8)

wherein F( ) is a function that generates a public address based on a deterministic key.

A transaction in relation to a checkout terminal (for example, checkout terminal 407) occurs, method 200 may add an entry to the look-up table 420. For example, a payment is made from a customer to a public address used by checkout terminal 407, which is derived from the deterministic key associated with checkout 407. If the public address used by checkout terminal 407 is not stored in the look-up table 420, method 200 adds a new entry to the look-up table 420 and stores the deterministic key (i.e., “GV407”) associated with checkout terminal 407 in the new entry of the look-up table 420 in association with the public address used by checkout terminal 407, as shown in the first entry and the third entry of the look-up table 420. In other examples, the deterministic key associated with checkout terminal 407 is already stored in an entry of the look-up table 420 before the transaction occurs. In this case, the method 200 stores the public address used by checkout terminal 407 in the entry in which the deterministic key is stored to associate the public address with the deterministic key. As a result, each entry of the look-up table 420 includes the deterministic key associated with one of checkout terminals 407 to 413 and one of the public addresses that is used by the one of checkout terminals 407 to 413.

At close of a business day, the store manager of store 403 may want to have an accounting report for store 403. The store manager selects an accounting item (for example, “the number of transactions with store 403”) associated with store 403 by for example inputting the MID associated with store 403. In this example, the accounting item and the MID associated with store 403 are sent to the accounting server 111 over the communication network 101.

Method 200 receives the MID and the accounting item associated with store 403 from the communication network 101. Method 200 determines a first deterministic key associated with store 403 based on the MID associated with the store 403 if store 403 is a root store. If store 403 is not a root store, the first deterministic key may be determined based on the deterministic key associated with the parent store 401 and the MID associated with store 403. Method 200 further determines the deterministic keys (e.g., “GV407”, “GV409”) associated with child entities or checkout terminals 407 and 409 of store 403 based on the first deterministic key and the respective TIDs of checkout terminals 407 and 409.

By searching the look-up table 420 for entries having any one of the deterministic keys “GV407” and “GV409” associated with checkout terminal 407 and 409 in the “Deterministic Key” field 413, method 200 determines a fourth set of public addresses associated with the deterministic keys “GV407” and “GV409”, wherein the fourth set of public addresses is a subset of the public addresses. As shown in FIG. 4(b), the fourth set of public addresses determined above includes the public addresses contained in the “Public Address” field 411 of the first three entries of the look-up table 420.

Method 200 further determines a fourth set of transactions in the blockchain 109 based on the fourth set of public addresses as described above, wherein the fourth set of transactions is a subset of the transactions. Method 200 further generates a third accounting report based on the fourth set of transactions as described above. Method 200 may also store the third accounting report in a storage device.

Since the public addresses used by stores 401 to 405 and checkout terminals 407 to 413 are derived from their respective deterministic keys, method 200 can determine the fourth set of public addresses by applying the deterministic keys associated with checkout terminals 407 to 413 to (Equation-8) without searching the look-up table 420.

It should be noted that, in the present disclosure, the public addresses include public keys of asymmetric cryptography pairs, each of the asymmetric cryptography pairs including one of the public keys and a private key corresponding to the one of the public keys. Each of the asymmetric cryptography pairs may be generated based on the Elliptic Curve Cryptography (ECC) algorithm.

Further, in a Bitcoin system, the public addresses are Bitcoin addresses of the entities used in Bitcoin protocols.

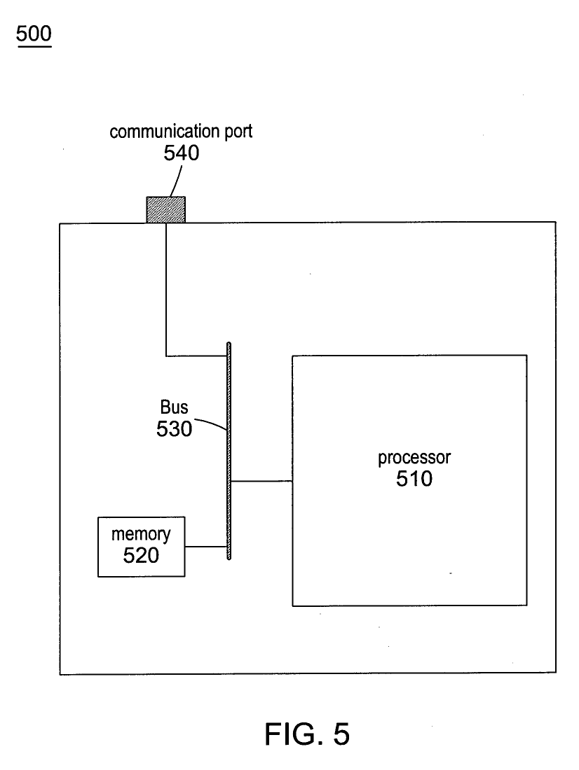

FIG. 5 illustrates an example schematic diagram of a computer system 500 used to implement the methods described. The computer system 500 can be an example of the accounting server 111.

The computer system 500 includes a processor 510, a memory device 520, a bus 530, and a communication interface 540. The processor 510, the memory device 520, and the communication interface 540 are connected via the bus 530 to communicate with each other. The communication interface 540 of the computer system 500 is used to connect the computer system 500 to the communication network 101, as shown in FIG. 1. The communication interface 540 may be an Internet interface, a WLAN interface, a cellular telephone network interface, a Public Switch Telephone Network (PSTN) interface, and an optical communication network interface, or any other suitable communication interface.

The processor 510 performs machine executable instructions stored in the memory 520 to implement the example methods described above with reference to FIGS. 1 to 4(b). The machine executable instructions are included in a computer software program. The computer software program resides in the memory device 520 in this example. In other examples, the computer software program is stored in a computer readable medium that is not part of the computer system 500, and is read into the memory device 520 from the computer readable medium. Specifically, the processor 510 is configured to:

associate public addresses of the entities with one or more identifiers of a first classification type to classify the public addresses based on the first classification type;

receive, from a communication network, a first identifier of the one or more identifiers of the first classification type;

determine a first set of public addresses associated with the first identifier, wherein the first set of public addresses is a subset of the public addresses; and

determine a first set of transactions in the peer-to-peer distributed ledger based on the first set of public addresses associated with the first identifier, wherein the first set of transaction is a subset of the transactions.

It should be understood that the example methods of the present disclosure might be implemented using a variety of technologies. For example, the methods described herein may be implemented by a series of machine executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as internet.

It should also be understood that, unless specifically stated otherwise as apparent from the following discussion, it is appreciated that throughout the description, discussions utilizing terms such as “determining”, “obtaining”, or “receiving” or “sending” or “generating” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method comprising:
associating public addresses of a plurality of entities with one or more identifiers of a first classification type to classify the public addresses based on the first classification type;
receiving, from a communication network, a first identifier of the one or more identifiers of the first classification type;
determining a first set of public addresses associated with the first identifier, wherein the first set of public address is a subset of the public addresses; and
identifying a first set of transactions in a blockchain based on the first set of public addresses associated with the first identifier.

2. The computer-implemented method of claim 1, further comprising:
receiving, from the communication network, a first data item associated with the first identifier; and
generating a first data output based on the first data item and the first set of transactions.

3. The computer-implemented method of claim 2, further comprising:
receiving, from a communication network, a second data item associated with a second identifier of the one or more identifiers of the first classification type;
determining a second set of public addresses associated with the second identifier, wherein the second set of public addresses is a subset of the public addresses;
determining a second set of transactions in the blockchain based on the second set of public addresses associated with the second identifier, wherein the second set of transactions is a subset of the transactions;
generating a second data output based on the second data item and the second set of transactions;
performing a first hash operation on the first data output to generate a first output hash representation for the first data output;
performing a second hash operation on the second data output to generate a second output hash representation for the second data output;
combining the first output hash representation and the second output hash representation; and
perform a third hash operation on the combined first output hash representation and second output hash representation to generate a third hash output representation for the combined first output hash representation and second output hash representation.

4. The computer-implemented method of claim 3, further comprising storing the third output hash representation in a storage device.

5. The computer-implemented method of claim 3, further comprising:
combining the first data output and the second data output; and
performing a hash operation on the combined first data output and second data output to generate a hash representation for the combined first data output and second data output.

6. The computer-implemented method of claim 1, further comprising:
associating the public addresses of the entities with one or more identifiers of a second classification type to classify the public addresses based on the second classification type;
receiving, from the communication network, a third identifier of one or more classification identifiers of the second classification type;
determining a third set of public addresses associated with the third identifier and the first identifier, wherein the third set of public addresses is a subset of the public addresses; and
determining a third set of transactions in the blockchain based on the third set of public addresses associated with the third identifier and the first identifier, wherein the third set of transactions is a subset of the transactions.

7. The computer-implemented method of claim 1, wherein the first classification type represents a classification of the public addresses by identity of the entities.

8. The computer-implemented method of claim 1, wherein the one or more identifiers of the first classification type includes one or more of the following:
names of the entities;
hexadecimal codes of the names;
Australian Business Numbers of the entities;
Network address; or
Australian Company Numbers of the entities.

9. The computer-implemented method of claim 6, wherein the second classification type represents a classification of the public addresses by account type of the entities.

10. The computer-implemented method of claim 9, and the one or more identifiers of the second classification type comprise any one or more of the following accounts:
credit account;
debit account;
accounts receivable;
accounts receivable;
salary account; and/or
interest account.

11. The computer-implemented method of claim 1, wherein associating the public addresses of the entities with the one or more identifiers of the first classification type comprises:
storing, in entries of a look-up table, the one or more identifiers of the first classification type in association with the public addresses of the entities, each entry of the look-up table including one of the one or more identifiers of the first classification type and one of the public addresses.

12. The computer-implemented method of claim 1, wherein associating the public addresses of the entities with the one or more identifiers of the first classification type comprises:
using a script to associate the one or more identifiers of the first classification type with the public addresses in the blockchain.

13. The computer-implemented method of claim 1, wherein the first classification type represents a classification of the public addresses by a tree structure that links the entities.

14. The computer-implemented method of claim 13, wherein the one or more identifiers of the first classification type comprise deterministic keys associated with the entities, wherein the deterministic keys are generated based on the tree structure.

15. The computer-implemented method of claim 13, wherein the entities include a parent entity and a child entity associated with the parent entity in the tree structure, wherein
the parent entity is associated with a first deterministic key of the deterministic keys, and the child entity is associated with a second deterministic key of the deterministic keys, and
the first deterministic key is determined based on a parent indication associated with the parent entity, and the second deterministic key is determined based on the first deterministic key and a child indication associated with the child entity.

16. The computer-implemented method of claim 15, further comprising:
receiving the parent indication from the communication network;
determining the first deterministic key based on the parent indication;
determining the second deterministic key based on the first deterministic key and the child indication;
determining a fourth set of public addresses associated with the second deterministic key, wherein the fourth set of public addresses is a subset of the public addresses;
determining a fourth set of transactions in the blockchain based on the fourth set of public addresses associated with the second deterministic key, wherein the fourth set of transactions is a subset of the transactions; and
generating a third data output based on the fourth set of transactions.

17. The computer-implemented method of claim 16, wherein determining the fourth set of public addresses further comprises determining the fourth set of public addresses based on the second deterministic key.

18. The computer-implemented method of claim 1, wherein the public addresses comprise public keys of asymmetric cryptography pairs, each of the asymmetric cryptography pairs including one of the public keys and a private key corresponding to the one of the public keys.

19. The computer-implemented method of claim 1, wherein the blockchain is generated in accordance with a Bitcoin protocol.

20. The computer-implemented method of claim 19, wherein the public addresses comprise Bitcoin addresses of the entities used in the Bitcoin protocol.

21. A computer system comprising at least one processor configured to:
associate public addresses of a plurality of entities with one or more identifiers of a first classification type to classify the public addresses based on the first classification type;
receive, from a communication network, a first identifier of the one or more identifiers of the first classification type;
determine a first set of public addresses associated with the first identifier, wherein the first set of public addresses is a subset of the public addresses; and
determine a first set of transactions in a blockchain based on the first set of public addresses associated with the first identifier.

22. A method of generating public keys for a linked or associated structure of entities, comprising the step of:
applying a function to a deterministic key to generate a public key, the deterministic key being generated by applying a hash function to either a parent entity identifier to generate a parent deterministic key, or to a sum of the parent deterministic key and a child entity identifier to generate a child deterministic key.

23. A method according to claim 22 and further comprising the steps of any of claim 1.
